(19) United States
(12) Patent Application Publication
(10) Pub. No.: US 2023/0202781 A1
(43) Pub. Date: Jun. 29, 2023

(54) SHEET CONVEYING APPARATUS, IMAGE RECORDING APPARATUS AND ROLL BODY REPLACING METHOD

(71) Applicant: BROTHER KOGYO KABUSHIKI KAISHA, Nagoya (JP)

(72) Inventors: Yoji Tsujishita, Ichinomiya (JP); Yoshiya Tomatsu, Kasugai (JP); Mitsugi Tanaka, Nagoya (JP)

(21) Appl. No.: 18/066,556

(22) Filed: Dec. 15, 2022

(30) Foreign Application Priority Data
Dec. 27, 2021 (JP) 2021-212065

(51) Int. Cl. B65H 5/02

(52) U.S. Cl. CPC B65H 5/021; B65H 2301/44322; B65H 2402/44

(57) ABSTRACT

There is provided a sheet conveying apparatus including: a casing having an opening; a cover configured to uncover and cover the opening; a holder configured to hold a roll body, the roll body including a sheet being rolled; a slidable support attached to the casing, the slidable support being configured to support the holder, the slidable support being configured to slide to an accommodated position at which the slidable support is accommodated within the casing and to a drawn position at which at least a part of the slidable support is positioned at outside of the casing with respect to the opening; and a conveyer configured to convey the sheet of the roll body in a state that the slidable support is at the accommodated position.

### REFERENCE TO RELATED APPLICATIONS

This application claims priority from Japanese Patent Application No. 2021-212065 filed on Dec. 27, 2021. The entire content of the priority application is incorporated herein by reference.

### BACKGROUND ART

As a sheet conveying apparatus configured to draw a sheet from a roll body including the sheet being rolled (wound) and to convey the drawn sheet, for example, there is a known apparatus such as a plotter. The plotter may be provided with a supporting stand having: a roll paper shaft penetrating through a roll paper-winding hole for roll paper, supporting plates supporting both end parts of the roll paper shaft, and a rail supporting the supporting plates.

### DESCRIPTION

In a plotter described in Japanese Patent Application Laid-open No. HEI 09-002709, the supporting stand is incorporated in the inside of the plotter; thus, in a case that the roll paper is replaced, there is a need to take out the used roll paper or a core of the roller paper to the outside, or to bring new roll paper to the supporting stand while supporting the new roll paper. In particular, in a case that a relatively large roll paper is to be set in the supporting stand, an operator consequently moves the roll paper in a direction away from the body of the operator while supporting the roll paper with both of his or her hands, and thus the roll paper is felt to be heavier.

An object of the present disclosure is to provide a sheet conveying apparatus capable of smoothly replacing a roll body including a sheet being rolled, an image recording apparatus provided with the sheet conveying apparatus, and a roll body replacing method.

(1) A sheet conveying apparatus according to an aspect of the present disclosure includes: a casing having an opening; a cover configured to uncover and cover the opening; a holder configured to hold a roll body, the roll body including a sheet being rolled; a slidable support attached to the casing, the slidable support being configured to support the holder, the slidable support being configured to slide to an accommodated position at which the slidable support is accommodated within the casing and to a drawn position at which at least a part of the slidable support is positioned at outside of the casing with respect to the opening; and a conveyer configured to convey the sheet of the roll body in a state that the slidable support is at the accommodated position.

According to the aspect of the present disclosure, since the operator is capable of sliding the slidable support to the drawn position at which at least the part of the slidable support is positioned at the outside of the casing with respect to the opening of the casing, the operator is capable of detaching (taking out) the roll body from the holder at the drawn position of the slidable support. Accordingly, an operation of supporting the roll body in a case that the roll body is being taken out from the inside of the casing is reduced or made easy. The operator is capable of sliding the slidable support up to the accommodated position at which the slidable support is accommodated in inside of the casing, in a state that the holder holding the roll body is supported by the slidable support. Accordingly, the operation of supporting the roll body in a case that the roll body is being accommodated in the inside of the casing is reduced or made easy. Thus, the operator is capable of replacing the roll body smoothly.

(2) In the sheet conveying apparatus according to an aspect of the present disclosure, the slidable support may have a handle.

Since the operator is capable of sliding the slidable support up to the drawn position, by hooking his or her finger(s) to the handle, the operator is capable of easily sliding the slidable support to the outside of the casing.

(3) In an aspect of the present disclosure, the cover may be configured so that first one of an upper end side and a lower end side of the cover rotates, with second one of the upper end side and the lower end side of the cover as a rotation axis. The slidable support may be configured to slide in a direction orthogonal to an axis line of the rotation axis.

Since the slidable support slides in a direction in which the cover rotates, the operator can easily recognize a sliding direction of the slidable support.

(4) In an aspect of the present disclosure, the cover may be configured so that the upper end side of the cover rotates with the lower end side of the cover as the rotation axis.

In a case that the slidable support is at the drawn position, the cover is positioned at a location below or under the slidable support. Accordingly, in a case that the operator replaces the roll body at the drawn position, the cover does not hinder the replacement of the roll body. Accordingly, the replacement of the roll body can be performed smoothly.

(5) In an aspect of the present disclosure, the conveyer may be configured to convey the sheet along a front-rear direction of the casing. The opening may be positioned at a lower rear part of one of side walls in a left-right direction of the casing, the left-right direction being orthogonal to the front-rear direction of the casing and orthogonal to an up-down direction of the casing.

In a case that the opening is arranged at a lower part and a front part of one of side walls in the left-right direction of the casing, there is a need to once convey the sheet rearward and to lift the sheet upward, and then to convey the sheet frontward. In the above-descried configuration, since the sheet can be drawn upward and then conveyed frontward, a conveyance route of the sheet can be made short.

(6) In an aspect of the present disclosure, the holder supported by the slidable support is configured to hold the roll body so that an axis line of the roll body is along the left-right direction of the casing.

The conveying part is capable of conveying the sheet, drawn from the roll body, easily in the front-rear direction.

(7) In an aspect of the present disclosure, the slidable support may include: a slide rail; and a holding stand supported by the slide rail, the holder being configured to be attached to and detached from the holding stand. The holder may include: a bar configured to be inserted into a central hole of the roll body; a first flange configured to be positioned at a first end of the bar so as to face a first end surface of the roll body; and a second flange configured to be positioned at a second end of the bar so as to face a second end surface of the roll body.

Since the first end surface and the second end surface of the roll body are covered, respectively, by the first flange and the second flange, such a situation that the operator touches the roll body in a case that the operator attaches and/or detaches the holder with respect to the holding stand is suppressed. Accordingly, the roll body is less likely to be dirtied.

(8) An image recording apparatus according to an aspect of the present disclosure includes: the sheet conveying apparatus as described above; and a recorder configured to record an image on the sheet conveyed by the conveyer.

According to the aspect of the present disclosure, it is possible to provide the image recording apparatus capable of exchanging the roll body smoothly.

(9) In an aspect of the present disclosure, the recorder may be configured to discharge an ink toward the sheet.

It is possible to appropriately perform printing on the sheet.

(10) A roll body replacing method according to an aspect of the present disclosure is a method for replacing a roll body accommodated in an inside of a casing in a state that the roll body is held by a holder, the roll body including a sheet being rolled. The roll body replacing method includes: uncovering an opening of the casing by moving a cover of the casing; drawing a slidable support configured to support the holder to an outside of the casing via the opening; detaching the holder from the slidable support drawn to the outside of the casing and installing the holder holding a new roll body to the slidable support; sliding the slidable support, via the opening, to the inside of the casing; and covering the opening of the casing by moving the cover of the casing.

According to the aspect of the present disclosure, since the operator draws, in a drawing step, the slidable support to the outside of the casing, via the opening of the casing, the operator is capable of detaching, in an installing and detaching step, the holder from the slidable support at the outside of the casing. Accordingly, the operation of supporting the roll body in a case that the roll body is being taken out from the inside of the casing is reduced or made easy. Since the operator slidably moves, in an accommodating step, the slidable supporting part up to the inside of the casing in the state that the holder is installed in the slidable support, the operation of supporting the roll body in a case that the roll body is being accommodated in the inside of the casing is reduced or made easy. Thus, the operator is capable of replacing the roll body smoothly.

According to the present disclosure, it is possible to replace the roll body smoothly.

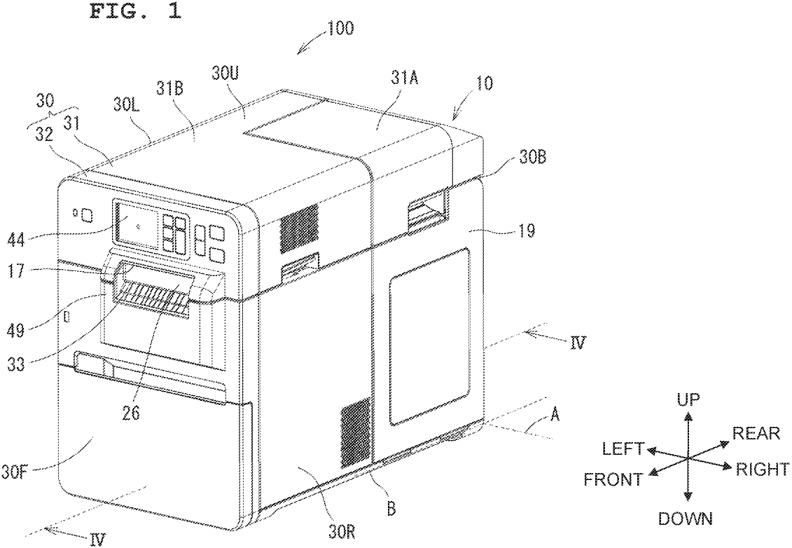

FIG. 1 is a perspective view of the outer appearance of an image recording apparatus 100.

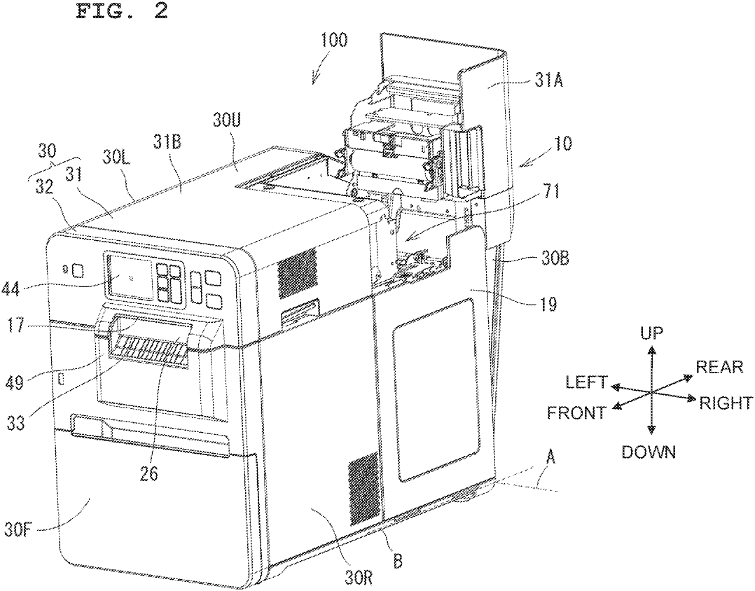

FIG. 2 is a perspective view depicting a state that a first upper cover 31A, of the image recording apparatus 100, is opened.

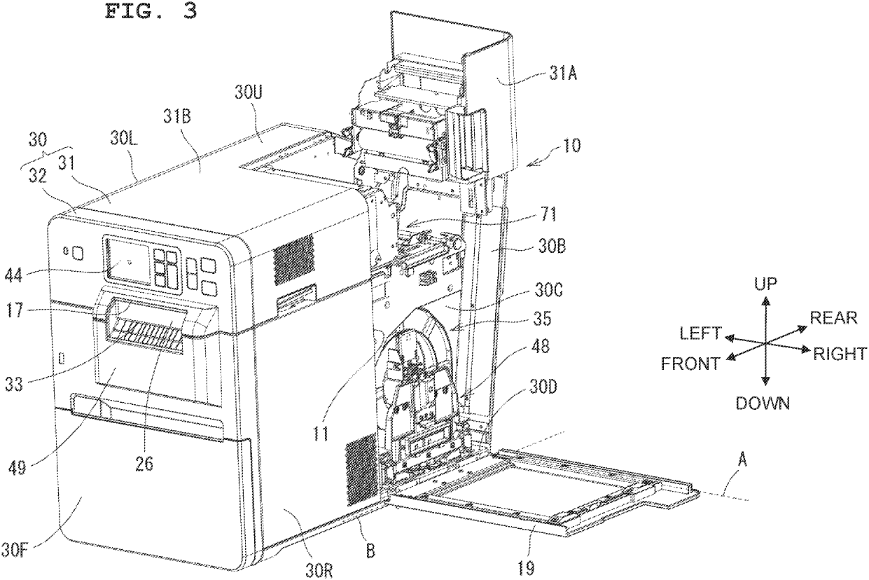

FIG. 3 is a perspective view depicting a state that a side cover 19, of the image recording apparatus 100, is opened.

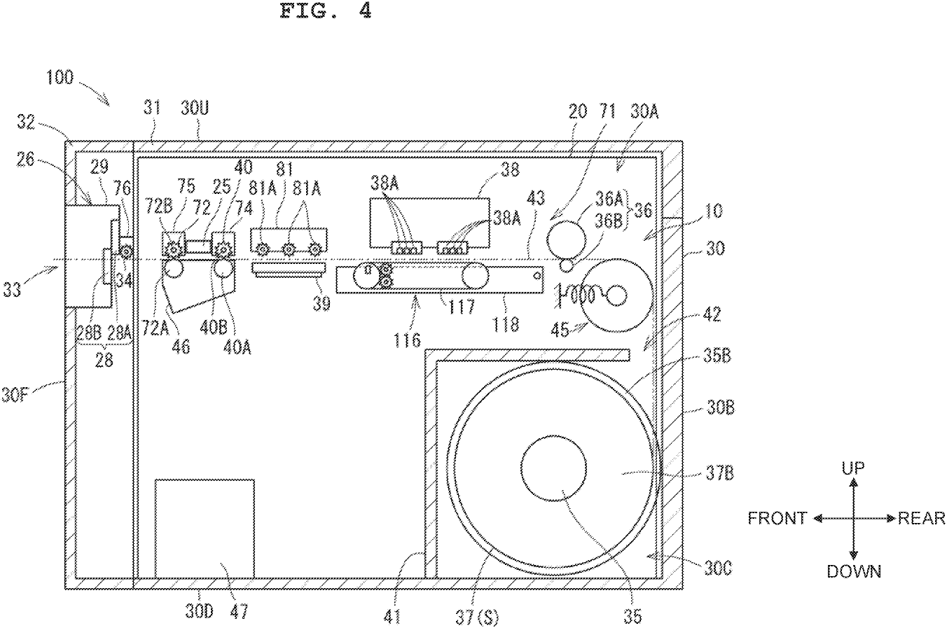

FIG. 4 is a cross-sectional view taken along a IV-IV line of FIG. 1.

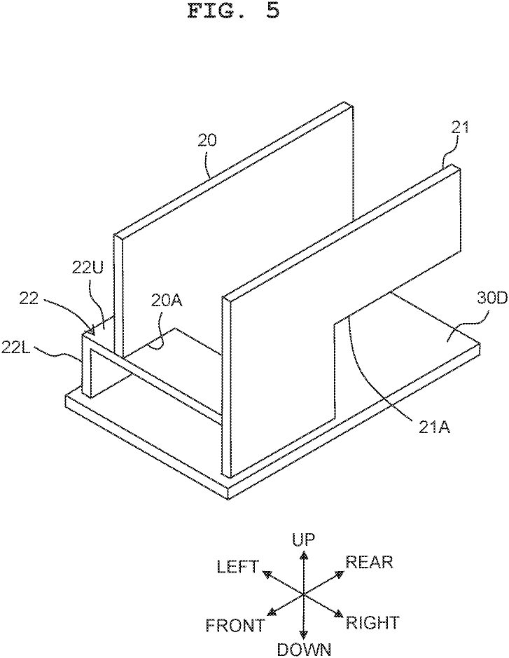

FIG. 5 is a perspective view of side frames 20, 21 of the image recording apparatus 100.

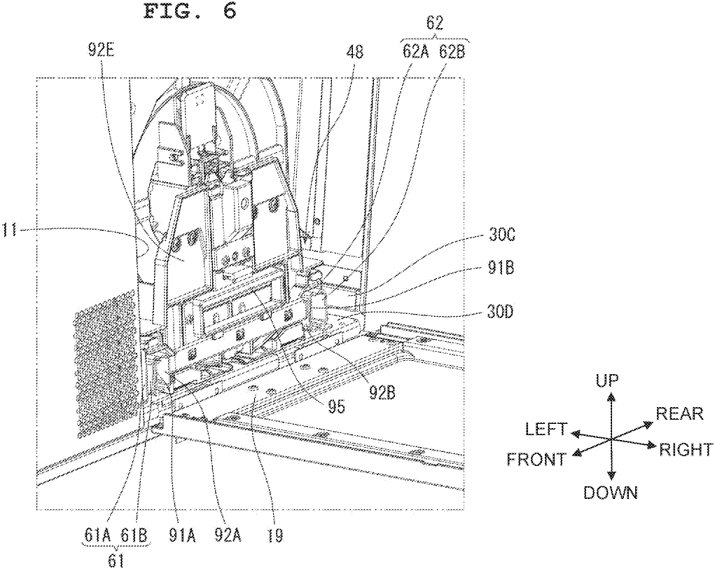

FIG. 6 is a perspective view depicting a state that a slidable supporting part 48, of the image recording apparatus 100, is at an accommodated position.

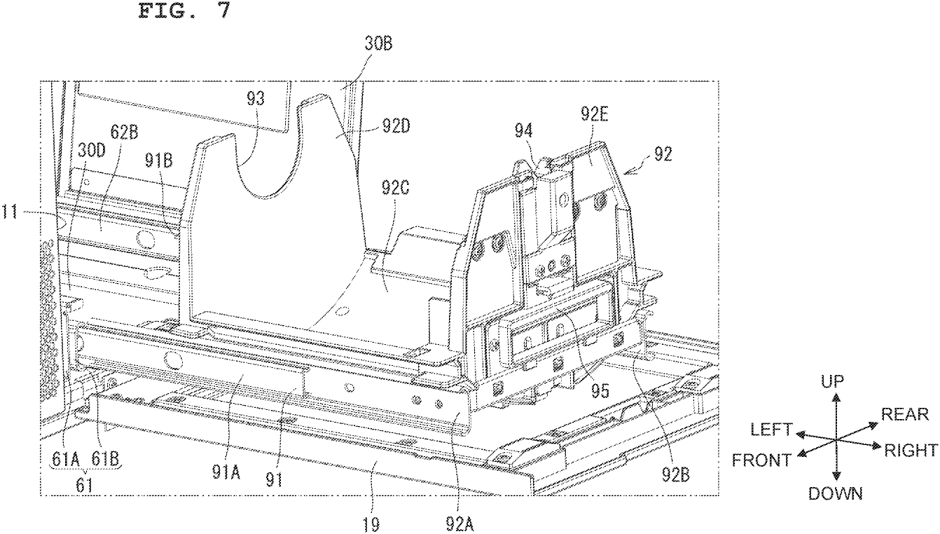

FIG. 7 is a perspective view depicting a state that a slidable supporting part 48, of the image recording apparatus 100, is at a drawn position.

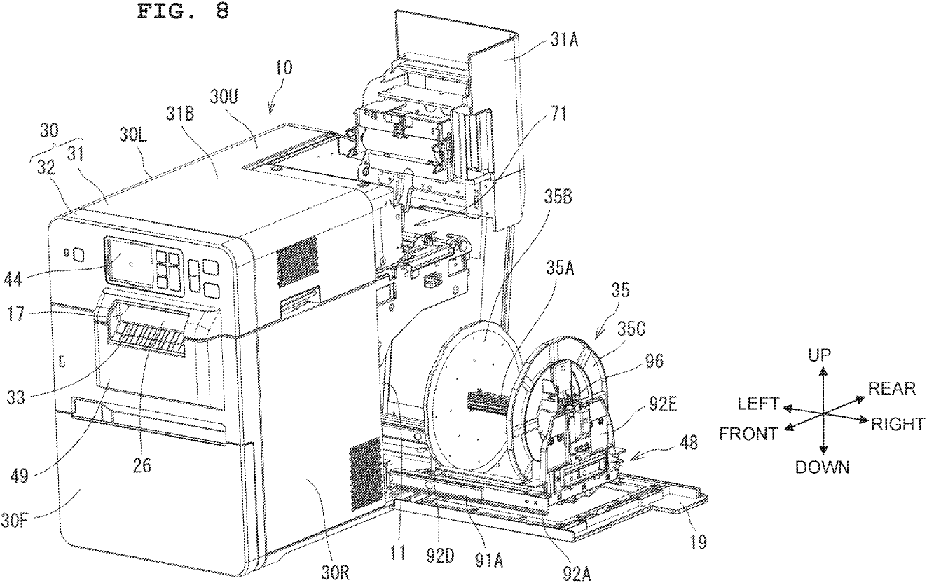

FIG. 8 is a view depicting a state that a roll body-holder 35, of the image recording apparatus 100, is supported by the slidable supporting part 48 at the drawn position.

In the following, an embodiment of the present disclosure will be explained, with reference to the drawings as appropriate. Note that the embodiment which is to be explained below is merely an example in which the present disclosure is embodied; it is needless to say that the embodiment can be appropriately changed without changing the gist of the present disclosure. In the following explanation, a direction (orientation) in which a discharge port 33 faces or is oriented is referred to as a front direction (front orientation), a direction (orientation) opposite to the front direction is referred to as a rear direction (rear orientation). The front direction and the rear direction are collectively referred to as a front-rear direction. An up-down direction orthogonal to the front-rear direction is referred to as an up-down direction. A direction orthogonal to the front-rear direction and the up-down direction is referred to as a left-right direction. The up direction (up orientation) of the up-down direction is referred to as an up direction (up orientation), the down direction (down orientation) in the up-down direction is referred to as a down direction (down orientation). In a case that an image recording apparatus 100 is seen in the rear direction, the left direction (orientation) of the left-right direction is referred to as a left direction (left orientation), and the right direction (right orientation) in the left-right direction is referred to as a right direction (right orientation).

### OUTER CONFIGURATION OF IMAGE RECORDING APPARATUS 100

As depicted in FIGS. 1 and 4, the image recording apparatus 100 has: a sheet conveying apparatus 10 configured to draw a sheet S from a roll body 37 and to convey the sheet S in the front direction; a recording part 38 configured to record, in the ink-jet recording system, an image on the sheet S drawn from the roll body 37; and a cutter unit 26 configured to cut the sheet S on which the image is recorded.

The sheet conveying apparatus 10 is provided with a casing 30, a side cover 19 (an example of a “cover”), a slidable supporting part 48, a roll body-holder 35 (an example of a “holder”) and a conveyor 71. The casing 30 has, as a whole, a shape which is substantially rectangular parallelepiped, and has a size which can be placed on a table, desk, etc. The casing 30 is provided with a body 31 and a front cover 32 installed in the body 31. In the following, in a case that an explanation is made regarding the casing 30, the explanation is made assuming that the body 31 and the front cover 32 have the rectangular parallelepiped shape as a whole.

The casing 30 has a right wall part 30R, a left wall part 30L, an upper wall part 30U, a lower wall part 30D, a front wall part 30F, and a rear wall part 30B. The right wall part 30R and the left wall part 30L are positioned apart in the left-right direction. The upper wall part 30U and the lower wall part 30D are positioned apart in the up-down direction. The front wall part 30F and the rear wall part 30B are positioned apart in the front-rear direction.

As depicted in FIGS. 2 and 3, a first opening 11 (an example of an “opening”) which opens or release a sheet accommodating space 30C (to be described later on) of the casing 30 to the outside is formed in the right wall part 30R. The first opening 11 is positioned at a lower part on the rear side of the right wall part 30R. Specifically, the first opening 11 spans from an intermediate position in the front-rear direction of the right wall part 30R and reaches up to the rear wall part 30B. The first opening 11 spans from an upper part of the right wall part 30R and reaches up to the lower wall part 30D. The rear wall part 30B is connected or linked to a rear end part of the lower wall part 30D so that the rear wall part 30B is rotatable (pivotable) about a first rotation axis A extending in the left-right direction.

The body (main body) 31 has a first upper cover 31A and a second upper cover 31B. The first upper cover 31A forms a part on the rear side of the upper wall part 30U and a part of a upper part on the rear side of the right wall part 30R (see FIG. 1). The first upper cover 31A is connected to an upper end part of the rear wall part 30B so that the first upper cover 31A is rotatable about a second rotation axis extending in the left-right direction. The first upper cover 31A is rotated from a close portion depicted in FIG. 1 so that a part, of the first upper cover 31A, which is on the rear side of the upper wall part 30U is lifted upward and is rotated up to an open position depicted in FIG. 2. In a case that the first upper cover 31A is rotated up to the open position, an internal space 30A of the casing 30 is exposed to the outside.

The second upper cover 31B is positioned in front of (on the front side with respect to) the first upper cover 31A. The second upper cover 31B forms an upper part of the left wall part 30B, an upper part on the front side of the right wall part 30R, the front side of the upper wall part 30U, and a part on the rear side of the upper wall part 30U (see FIG. 1). The second upper cover 31B is connected to the upper end part of the rear wall part 30B so that the second upper cover 31B is rotatable about a third rotation axis extending in the left-right direction. The second upper cover 31B is rotated from a close portion depicted in FIG. 1 so that a part, of the second upper cover 31B, which is on the front side of the upper wall part 30U is lifted upward and is rotated up to an open position. In a case that the second upper cover 31B is rotated up to the open position, the internal space 30A of the casing 30 is exposed to the outside.

The front cover 32 covers a front end of the body 31. The front cover 32 is detachably installed to the front end of the body 31. A second opening 17, through which a discharge port 33 of a cutter unit 26 (to be described later on) is exposed to the outside, is formed in a front surface of the front cover 32. The second opening 17 is positioned at a location closer to the right end with respect to the center in the left-right direction in the front surface of the front cover 32. The front cover 32 has a bulge part 49 which bulges in the front direction from the front surface, of the front cover 32, at a location surrounding the second opening 17. The inside of the bulge part 49 has a shape in conformity with the outer shape of the cutter unit 26.

An operation panel 44 is provided on the front surface 32, at a location above the bulge part 49. The operation panel 44 receives input, from an operator, the input being for operating the image recording apparatus 100 or for confirming a variety of kinds of settings.

As depicted in FIG. 2 an 3, the side cover 19 is configured to be capable of opening (uncovering) and closing (covering) the first opening 11 of the casing 30. The side cover 19 is formed to have a shape of a flat plate. The side cover 19 is attached to a right end part of the lower wall part 30D to be rotatable about a third rotation axis B extending in the front-rear direction. The side cover 19 is rotatable between a close position at which the side cover 19 closes the first opening 11 and an open position at which the side cover 19 is rotated rightward from the close position. By the opening and closing of the side cover 19, the sheet accommodating space 30C of the casing 30 is opened and closed with respect to the outside.

As depicted in FIG. 5, two side frames 20, 21 and a sub frame 22 are provided on the internal space 30A of the casing 30. Each of the side frames 20, 21 has a shape of a flat plate made of a steel plate, and a cutout, a through hole, etc., of which shape(s) is/are in accordance with a member which is supported by each of the side frames 20, 21, is/are formed in each of the side frames 20 and 21, as appropriate. The two side frames 20, 21 are positioned to be apart from each other in the left-right direction. The side frames 20, 21 are connected to the lower wall part 30D of the casing 30. The connection between the side frames 20, 21 and the lower wall part 30D is made by a screwing, a welding, etc.

Regarding the two side frames 20 and 21, a front lower corner part of the side frame 20 which is located on the left side is formed with a cutout part 20A. Accordingly, a front end part of the side frame 20 is not connected to the lower wall part 30D, and a space corresponding to the cutout part 20A is defined. The sub frame 22 is provided on the space corresponding to the cutout part 20A. A rear lower corner part of the side frame 21 is formed with a cutout part 21A. The cutout part 21A is an opening via which the roll body 37 is loaded to the sheet accommodating space 30C (see FIG. 4).

The sub frame 22 has an upper wall 22U and a left wall 22L. The upper wall 22U connects an upper end of the left wall 22L and the side frame 21. A lower end of the left wall 22L is connected to the lower wall part 30D. The upper wall 22U is connected to the cutout part 20A of the side frame 20. With this, the sub frame 22 is positioned at a location below a front part of the side frame 20, thereby constructing an integrated frame together with the side frame 20.

### INTERNAL CONFIGURATION OF IMAGE RECORDING APPARATUS 100

As depicted in FIG. 4, the slidable supporting part (slidable support) 48 (which is omitted in FIG. 4 to simplify the drawing. See, FIGS. 3 and 6 to 8), the roll body-holder 35 (an example of a “holder”), a tensioner 45, the conveyor 71, the recording part 38, a supporting mechanism 116, a fixing part 39, a jam cover 81, a supporting member 46, a contact image sensor (hereinafter referred to as “CIS”) 25 are arranged at a location between the side frames 20, 21 in the internal space 30A of the casing 30.

In the internal space 30A of the casing 30, a partition wall 41 is provided between the side frames 20 and 21 in the left-right direction. The partition wall 41 partitions the lower part on the rear side of the internal space 30A so as to define the sheet accommodating space 30C. The sheet accommodating space 30C is a space surrounded by the partition wall 41, the rear wall part 30B, the lower wall part 30D and the side frame 20, and separated or isolated from the recording part 38, etc.

The roll body 37, the slidable supporting part 48 and the roll body-holder 35 are accommodated in the sheet accommodating space 30C. The slidable supporting part 48 and the roll body-holder 35 will be described later on. The roll body 37 has a core tube and a long sheet S. The sheet S is rolled (wound) around the core tube in a roll shape in a circumferential direction of the axial core of the core tube. The sheet S may have a width ranging from a minimum width to a maximum width in which the image recording apparatus 100 is capable of recording an image. Namely, a plurality of types of the roll body 37 having different widths are accommodatable in the sheet accommodating space 30C. Note that it is allowable to provide such a configuration that the roll body 37 does not have the core tube and that the sheet S is rolled in a roll shape so that the sheet S is installable in the roll body-holder 35.

A rear part of the sheet accommodating space 30C is opened upward. Specifically, a gap 42 is defined between the partition wall 41 and the rear wall part 30B, namely, at a position above a rear end of the roll body 37. By the conveyor 71, the sheet S is drawn upward from the rear end of the roll body 37, and the drawn sheet S is guided to the tensioner 45 via the gap 42.

At a rear part of the internal space 30A, the tensioner 45 is positioned above the partition wall 41. The tensioner 45 is a roller supported by the side frames 20, 21 so that the tensioner 45 is rotatable. The tensioner 45 is supported by the side frames 20, 21 so that the tensioner 45 is movable in the front-rear direction. An urging force in the rear direction is applied to the tensioner 45 by an urging member such as a spring, etc.

The conveyor 71 is configured to be capable of conveying the sheet S in a state that the slidable supporting part 48 is at an accommodated position (to be described later on). The conveyor 71 draws the sheet S from the roll body 37, and conveys the sheet S in the front direction 51. The conveyor 71 has a conveying roller pair 36, a first discharging roller pair 40, and a second discharging roller pair 72.

The conveying roller pair 36 is positioned in front of the tensioner 45. The conveying roller pair 36 has a conveying roller 36B and a pinch roller 36A. The conveying roller 36B is rotatably supported by the frames 20 and 21. The conveying roller 36B rotates by receiving a driving force from a non-illustrated motor, thereby conveying the sheet S in the front direction while nipping the sheet S between the conveying roller 36B and the pinch roller 36A.

The first discharging roller pair 40 is positioned in front of the conveying roller pair 36. The first discharging roller pair 40 has a discharging roller 40A which makes contact with a lower surface of the sheet S, and a spur 40B which makes contact with an upper surface of the sheet S. The discharging roller 40A is rotatably supported by the side frames 20, 21. The spur 40B is rotatably supported by a first spur holder 74 which is supported by an inner wall surface of the second upper cover 31B. The discharging roller 40A rotates by receiving a driving force from a non-illustrated motor, thereby conveying the sheet S in the front direction while nipping the sheet S between the discharging roller 40A and the spur 40B.

The second discharging roller pair 72 is positioned in front of the first discharging roller pair 40. The second discharging roller pair 72 has a discharging roller 72A which makes contact with the lower surface of the sheet S, and a spur 72B which makes contact with the upper surface of the sheet S. The discharging roller 72A is rotatably supported by the side frames 20, 21. The spur 72B is rotatably supported by a second spur holder 75 which is supported by the inner wall surface of the second upper cover 31B. The discharging roller 72A rotates by receiving a driving force from a non-illustrated motor, thereby conveying the sheet S in the front direction while nipping the sheet S between the discharging roller 72A and the spur 72B.

The recording part 38 is positioned at a location which is in front of (on the front side with respect to) the conveying roller pair 36 and behind (on the rear side with respect to) the first discharging roller pair 40. The recording part 38 has a plurality of nozzles 38A. Each of the plurality of nozzles 38A discharges or ejects an ink, as a liquid droplet, toward the sheet S supported by the supporting mechanism 116. With this, an image is recorded on the upper surface of the sheet S. An ink tank 47 which is arranged in the internal space 30A of the casing 30, at a lower part on the front side of the internal space 30A is connected to the recording part 38 by a non-illustrated tube so that the ink can be supplied from the tank 47 to the recording part 38.

As the ink, a water-based ink which includes water, a pigment and thermoplastic resin fine particles is used. Note that the ink is not particularly limited. In the present embodiment, the ink adhered to the sheet S is heated by the heating part 39 to thereby melt the thermoplastic resin fine particles; and then the ink is subjected to cooling thereafter to thereby cure or harden the molten resin, thereby fixing the pigment included in the ink to the sheet S.

The supporting mechanism 116 is positioned at a location in front of the conveying roller pair 36. The supporting mechanism 116 is positioned below the recording part 38. The supporting mechanism 116 face or is opposite to the recording part 38 in the up-down direction. The supporting mechanism 116 has a conveying belt 117, and a supporting part 118 which supports the conveying belt 117. A driving force from a non-illustrate motor is transmitted to the conveying belt 117 so as to drive and rotate the conveying belt 117, thereby causing the conveying belt 117 to convey the sheet S in the front direction while supporting the lower surface of the sheet S.

The fixing part 39 is positioned, in the front-rear direction, between the recording part 38 and the first discharging roller pair 40. The fixing part 39 is fixed to the side frames 20, 21. The fixing part 39 supports the lower surface of the sheet S which is (being) conveyed in the front direction by the conveying belt 117. The fixing part 39 heats the sheet S. With this, while the sheet S is passing the fixing part 39, the thermoplastic resin fine particles included in the ink is melt by the heating, and the molten resin is cured by a cooling by the atmosphere after the sheet S has passed the fixing part 39, thereby fixing the pigment to the upper surface of the sheet S.

The jam cover 81 is arranged so as to cover a location above the fixing part 39. The jam cover 81 is attached to the side frames 20, 21. The jam cover 81 has a plurality of spurs 81A which make contact with the upper surface of the sheet S which is (being) conveyed in the front direction by the conveying belt 117.

The supporting member 46 is positioned in front of the fixing part 39. A front part of the supporting member 46 faces or is opposite to the spur 72B in the up-down direction. A rear part of the supporting member 46 faces or is opposite to the spur 40B in the up-down direction. The supporting member 46 supports the lower surface of the sheet S which is (being) conveyed in the front direction by the first discharging roller pair 40.

The CIS 25 is positioned in front of the fixing part 39. The CIS 25 is positioned above the supporting member 46. The CIS 25 is positioned, in the front-rear direction, between the first discharging roller pair 40 and the second discharging roller pair 72. In a case that a reflected light, of a light emitted or radiated from a light source such as an LED and reflected off (by) the sheet S, is collected by gradient index lenses (GRIN lenses) and to a line sensor, the CIS 25 is configured to output an electric signal corresponding to the intensity of the reflected light received by the line sensor. The CIS 25 is configured to output an electric signal corresponding to a reflected light by an image on the upper surface of the sheet S. A direction in which the line sensor of the CIS 25 is aligned, namely a reading line, is along the left-right direction. A length of the reading line of the CIS 25 is longer than the maximum width, of the sheet S, in which the image recording apparatus 100 is capable of recording an image.

The cutter unit 26 is detachably attached to the body 31 of the sheet conveying apparatus 10, in the inside of the bulge part 49 of the front cover 32. The cutter unit 26 is positioned in front of the second discharging roller pair 72. The cutter unit 26 has a cutter 28 configured to cut the sheet S, and a cutter holder 29 configured to hold the cutter 28.

The cutter 28 cuts, along the left-right direction, the sheet S pinched by the second discharging roller pair 72. Note that the cutting mechanism of the cutter 28 is not particularly limited or restricted, provided that the cutter 28 is capable of cutting the sheet S along the left-right direction. For example, it is allowable that the cutter 28 cuts the sheet S by causing a lower blade 28B to move upward with respect to an upper blade 28A.

An attaching holder 76 configured to hold a spur 34 is attached to a rear surface of the cutter holder 29. The attaching holder 76 is detachably attached to the body 31 of the sheet conveying apparatus 10. The discharge port 33 via which the sheet S is discharged is formed in a front surface of the cutter holder 29. The discharge port 33 is exposed from the second opening 17 of the front cover 32 to the outside (see FIG. 1).

A substrate (not depicted in the drawings) is fixed to the side frame 20 on the left side. An arithmetic element serving as a controller, a chip for a communication interface, various connectors, etc., are mounted on the substrate. The substrate is connected, by a non-illustrated flat cable, etc., to the motors driving the recording part 38, the cutter 28, etc., and to the operation panel 44, etc., so that an electrical signal can be transmitted and received. Further, an electric power is supplied from a non-illustrated power supply unit to the substrate.

As depicted in FIG. 6, a front supporting part 61 and a rear supporting part 62 configured to slidably support the slidable supporting part 48 are arranged in the sheet accommodating space 30C. The front supporting part 61 and the rear supporting part 62 are arranged in the front-rear direction with a spacing distance therebetween. The front supporting part 61 is positioned in front of the rear supporting part 62.

The front supporting part 61 has a front standing wall 61A extending in the up direction from the upper surface of the lower wall part 30D, and a front guide wall 61B which is fixed along the front standing wall 61A. The front standing wall 61A is formed to have a shape which is a substantially flat plate extending in the up-down direction and the left-right direction. Each of a front surface and a rear surface of the front standing wall 61A has a shape which is substantially rectangular elongated in the left-right direction. The front guide wall 61B is fixed to the rear surface of the front standing wall 61A. The front guide wall 61B extends in the left-right direction along the front standing wall 61A. The front guide wall 61B is formed to have a shape which is substantially of a rearward-oriented letter “U” as seen from the left-right direction.

The rear supporting part 62 has a rear standing wall 62A extending in the up direction from the upper surface of the lower wall part 30D, and a rear guide wall 62B which is fixed along the rear standing wall 62A. The rear standing wall 62A is formed to have a shape which is a substantially flat plate extending in the up-down direction and the left-right direction. Each of a front surface and a rear surface of the rear standing wall 62A has a shape which is substantially rectangular elongated in the left-right direction. The rear guide wall 62B is fixed to the front surface of the rear standing wall 62A. The rear guide wall 62B extends in the left-right direction along the rear standing wall 62A. The rear guide wall 62B is formed to have a shape which is substantially of a frontward-oriented letter “U” as seen from the left-right direction.

The slidable supporting part 48 is arranged in the sheet accommodating space 30C of the casing 30. The slidable supporting part 48 is attached to the casing 30 to be slidable in the left-right direction via the first opening 11 of the casing 30. The slidable supporting part 48 is slidable to an accommodated position (see FIG. 6) at which the slidable supporting part 48 is accommodated in the sheet accommodating space 30C and to a drawn position (see FIG. 7) at which at least a part of the slidable supporting part 48 is drawn to the outside of the casing 30 with respect to the first opening 11. In the drawn position, at least a part of the slidable supporting part 48, specifically, for example, at least a part of the placement part 92C is drawn to the outside of the casing 30 with respect to the first opening 11. In this situation, at least a part of the roll body holder 35 placed on the placement part 92C is also positioned at the outside of the casing 30. Note that in FIG. 7, the entirety of the placement part 92C and the entirety of the roll body holder 35 are positioned at the outside of the casing 30. Note that it is allowable that a position, at which a part, of the slidable supporting part 48, which corresponds to not less than ½ (half) of the full width in the sliding direction (left-right direction) of the slidable supporting part 48 is drawn to the outside of the casing 30 is defined as the drawn position; it is also allowable that a position, at which a part, of the slidable supporting part 48, which corresponds to not less than ⅔ (two thirds) of the full width in the sliding direction of the slidable supporting part 48 is drawn to the outside of the casing 30 is defined as the drawn position. The slidable supporting part 48 has a slide rail 91 and a holding stand 92. The slide rail 91 has a front rail part 91A slidably supported by the front guide wall 61B, and a rear rail part 91B slidably supported by the rear guide wall 62B.

The front rail part 91A extends along the left-right direction. The front rail part 91A is formed to have a shape which is substantially of a rearward-oriented letter “U” as seen from the left-right direction and which is smaller than the front guide wall 61B. The front rail part 91A is positioned in the inside of the front guide wall 61B. The front rail part 91A is supported by the front guide wall 61B to be slidable up to a position at which the front rail part 91A protrudes rightward with respect to the front guide wall 61B from the inside of the front guide wall 61B.

The rear rail part 91B extends along the left-right direction. The rear rail part 91B is formed to have a shape which is substantially of a frontward-oriented letter “U” as seen from the left-right direction and which is smaller than the rear guide wall 62B. The rear rail part 91B is positioned in the inside of the rear guide wall 62B. The rear rail part 91B is supported by the rear guide wall 62B to be slidably movable up to a position at which the rear rail part 91B protrudes rightward with respect to the rear guide wall 62B from the inside of the rear guide wall 62B.

The holding stand 92 is a structure to detachably support the roll body-holder 35. The holding stand 92 has: a front connecting part 92A which is connected to the front rail part 91A to be movable in the left-right direction relative to the front rail part 91A; a rear connecting part 92B which is connected to the rear rail part 91B to be movable in the left-right direction relative to the rear rail part 91B; a placement part 92C positioned between the front connecting part 92A and the rear connecting part 92B; and a left holding plate 92D and a right holding plate 92E supported by the placement part 92C.

The front connecting part 92A extends along the left-right direction. The front connecting part 92A is formed to have a shape which is substantially of a frontward-oriented letter “U” as seen from the left-right direction and which is greater than the front rail part 91A. Accompanying with movement in the left-right direction of the front connecting part 92A, the front rail part 91A moves in the left-right direction to follow the movement in the left-right direction of the front connecting part 92A. The front connecting part 92A is movable between a position at which the front connecting part 92A is accommodated in the sheet accommodating space 30C and a position at which the front connecting part 92A protrudes rightward from the sheet accommodating space 30C. At the position at which the front connecting part 92A is accommodated in the sheet accommodating space 30C, the right end of the front connecting part 92A, the right end of the front rail part 91A, and the right end of the front supporting part 61 substantially overlap in the front-rear direction (see FIG. 6). At the position at which the front connecting part 92A protrudes rightward from the sheet accommodating space 30C, the front connecting part 92A protrudes rightward greatly than the front rail part 91A (see FIG. 7).

The rear connecting part 92B extends along the left-right direction. The rear connecting part 92B is formed to have a shape which is substantially of a rearward-oriented letter “U” as seen from the left-right direction and which is greater than the rear rail part 91B. Accompanying with movement in the left-right direction of the rear connecting part 92B, the rear rail part 91B moves in the left-right direction to follow the movement in the left-right direction of the rear connecting part 92B. The rear connecting part 92B is movable between a position at which the rear connecting part 92B is accommodated in the sheet accommodating space 30C and a position at which the rear connecting part 92B protrudes rightward from the sheet accommodating space 30C. At the position at which the rear connecting part 92B is accommodated in the sheet accommodating space 30C, the right end of the rear connecting part 92B, the right end of the rear rail part 91B, and the right end of the rear supporting part 62 substantially overlap in the front-rear direction (see FIG. 6). At the position at which the rear connecting part 92B protrudes rightward from the sheet accommodating space 30C, the rear connecting part 92B protrudes rightward greatly than the rear rail part 91B (see FIG. 7).

The placement part 92C has a shape which is obtained by curving, in the down direction, a flat plate which extends in the front-rear direction and the left-right direction. An upper surface of the placement part 92C is a surface having a circular arc shape along the outer circumferential surface of each of a left flange 35B and a right flange 35C (to be described later on) of the roll body-holder 35. The front connecting part 92A is fixed to a front end of the placement pace 92C. The rear connecting part 92B is fixed to a rear end of the placement part 92C.

The left holding plate 92D is provided to stand at a left end of the placement part 92C. The left holding plate 92D is formed to have a shape of a flat plate extending in the front-rear direction and the up-down direction. The left holding plate 92D has a left cutout part 93 which is formed by performing cutting in an upper end of the left holding plate 92D substantially in a semi-circular shape. The left cutout part 93 is positioned in the center in the front-rear direction of the left holding plate 92D.

The right holding plate 92E is provided to stand at a right end of the placement part 92C. The right holding plate 92E is formed to have a shape of a flat plate extending in the front-rear direction and the up-down direction. The right holding plate 92E faces the left holding plate 92D in the left-right direction. The right holding plate 92E has a right cutout part 94 which is formed by performing cutting in an upper end of the right holding plate 92E substantially in a semi-circular shape. The right cutout part 94 is positioned in the center in the front-rear direction of the right holding plate 92E. The right cutout part 94 is smaller than the left cutout part 93. A handle 95 to which a finger of the operator can be hooked is formed at a lower part in the right surface of the right holding plate 92E. The handle 95 is formed to have a rectangular frame which protrudes rightward from the right surface of the right holding plate 92E.

As depicted in FIG. 8, the roll body-holder (holder) 35 is detachably supported by the holding stand 92. The roll body-holder 35 has: a bar member (bar) 35A extending along the left-right direction; a left flange 35B (an example of a “first flange”) positioned at a left end part (an example of “first end”) of the bar member 35A; and a right flange 35C (an example of a “second flange”) positioned at a right end part (an example of the “second end”) of the bar member 35A. Note that in FIG. 8, the illustration of the roll body 37 is omitted so that the structure of the roll body-holder 35 is easily understood.

The bar member 35A is a member which is insertable into a core tube defining the central hole of the roll body 37. The bar member 35A supports the roll body 37 in a state that the axis line of the core tube is along the left-right direction. The bar member 35A supports the roll body 37 so that the roll body 37 is rotatable about the axis line of the core tube. A length in the left-right direction of the bar member 35A is substantially equal to a spacing distance in the left-right direction between the left holding plate 92D and the right holding plate 92E. The right end part of the bar member 35A is inserted into the right cutout part 94. The right end part of the bar member 35A is insertable and removable with respect to the right cutout part 94.

The left flange 35B is adjacent to the right surface of the left holding plate 92D. The left flange 35B extends from a left end of the bar member 35A substantially in a circular shape in a direction orthogonal to the bar member 35A. A length in the radial direction of the left flange 35B is longer than the diameter of the roll body 35. The left flange 35B is formed to have a polygonal shape which is substantially along the placement surface of the placement part 92C. In FIG. 8, the left flange 35B is formed to have a hexadecagonal shape (a polygon having sixteen corners). A central part of the left flange 35B is formed with a through hole penetrating therethrough in the left-right direction. A left end part of the bar member 35A is inserted into the through hole. The bar member 35A inserted into the through hole protrudes leftward from the left surface of the left flange 35B. In this state, the bar member 35A is fixed to the left flange 35B. The right surface of the left flange 35B faces, in the left-right direction, a left end surface (an example of a “first end surface”) of the roll body 37 into which the bar member 35A is inserted. With this, the left end surface of the roll body 37 is covered by the left flange 35B.

A protruding part having a substantially circular shape (not depicted in the drawings) is formed in the left surface of the left flange 35B, at a location from which the bar member 35A protrudes leftward. The protruding part is inserted into the left cutout part 93 of the left holding plate 92D. The protruding part is insertable and removable with respect to the left cutout part 93. A non-illustrated coupling mechanism is provided on a central part of the protruding part. In a case that the slidable supporting part 48 supporting the roll body-holder 35 is accommodated in an accommodated position (to be described later on), the coupling mechanism engages with a driving force transmitting mechanism of the sheet conveying apparatus 10. By this engagement, the driving force from the non-illustrated motor is transmitted to the roll body-holder 35, thereby rotating the roll body-holder 35. By this rotation of the roll body-holder 35, the roll body 37 installed in the roll body-holder 35 also rotates, thereby feeding the sheet S from the roll body 37.

The right flange 35C is adjacent to the left surface of the right holding plate 92E. A central part of the right flange 35C is formed with a through hole penetrating therethrough in the left-right direction. The bar member 35A is inserted into the through hole to be movable in the left-right direction. The right flange 35C extends from a right end of the bar member 35A substantially in a circular shape in the direction orthogonal to the bar member 35A. A length in the radial direction of the right flange 35C is equal to the length in the radial direction of the left flange 35B. The right flange 35C faces the left flange 35B in the left-right direction. The right flange 35C is formed to have a polygonal shape which is substantially along the placement surface of the placement part 92C. In FIG. 8, the right flange 35C is formed to have a hexadecagonal shape (a polygon having a sixteen corners). The left surface of the right flange 35C faces, in the left-right direction, a right end surface 37B (an example of a “second end surface”) of the roll body 37 into which the bar member 35A is inserted. With this, the right end surface 37B of the roll body 37 is covered by the right flange 35C.

A locking mechanism 96 configured to lock a position, of the right flange 35C, with respect to the bar member 35A is provided on the right surface of the right flange 35C. The operator release the locking by the lock mechanism 96 to thereby make it possible to adjust the position, of the right flange 35C, with respect to the bar member 35A. With this, the operator is capable of causing the roll body-holder 35 to change a spacing distance in the left-right direction between the left flange 35B and the right flange 35C. The operator is capable of causing the left flange 35B to make contact with the left end of the roll body 37 in accordance with the width (size along the left-right direction) of the roll body 37 which is installed in the roll body-holder 35, and to cause the right flange 35C to make contact with the right end of the roll body 37. The roll body 37 of which left and right ends make contact with the left flange 35B and the right flange 35C, respectively, is positioned so that the center in the width direction of the sheet S becomes to be the center in the left-right direction of a conveying route 43 of the sheet S.

The image recording apparatus 100 configured as described above operates in the following manner.

In a case that the driving force is transmitted from the non-illustrated motor to the roll body-holder 35, the sheet S is drawn from the roll body 37 installed in the roll body-holder 35 in the sheet accommodating space 30C, while the roll body 37 rotates about the axial core of the core tube. In this situation, the sheet S is drawn in the up direction via the gap 42.

The sheet S drawn from the roll body 37 is conveyed in the front direction while being nipped between the conveying roller 36B and the pinch roller 36A. The sheet S conveyed in the front direction by the conveying roller pair 36 is supported by the supporting part 118 of the supporting mechanism 116. In this situation, the ink is discharged downward from the plurality of nozzles 38A of the recording part 38 to thereby record an image on the upper surface of the sheet S. The sheet S having the image recorded on the upper surface thereof is conveyed in the front direction by the conveying belt 117.

The sheet S which is (being) conveyed in the front direction by the conveying belt 117 is supported by the upper surface of the fixing part 39. While the sheet S is passing on the fixing part 39, the sheet S and the ink are heated by the heat of the fixing part 39. With this, the thermoplastic resin fine particles included in the ink are melted, and then are subjected to cooling by the air thereafter to thereby cure or harden the molten thermoplastic resin fine particles, thereby fixing the pigment included in the ink to the sheet S.

The sheet S heated in the fixing part 39 is conveyed in the front direction while being nipped between the discharging roller 40A and the spurs 40B of the first discharging roller pair 40. The sheet S which is (being) conveyed in the front direction by the first discharging roller pair 40 is supported by the supporting member 46. In a case that the sheet S is supported by the supporting member 46, the CIS 25 radiates the light from the light source toward the upper surface of the sheet S, and outputs an electric signal in accordance with the intensity of a reflected light of the light reflected off the sheet S. With this, the image of the upper surface of the sheet S is read by the CIS 25.

The sheet S of which image has been read by the CIS 25 is conveyed in the front direction by the second discharging roller pair 72. The sheet S which is conveyed in the front direction by the second discharging roller pair 72 is cut along the left-right direction by the cutter unit 26 in a state that a front part of the sheet S is exposed from the discharge port 33 to the outside of the casing 30. The sheet S cut by the cutter unit 26 is discharged from the discharge port 33.

Next, a method of replacing the roll body 37 by using the image recording apparatus 100 will be explained.

First, an opening step of opening (uncovering) the first opening 11 which is opened in the right wall part 30R of the casing 30 is performed. As depicted in FIGS. 1 and 2, in the opening step, the operator firstly rotates the first upper cover 31A from the close position to the open position. Next, as depicted in FIGS. 2 and 3, the operator rotates the side cover 19 from the close position to the open position, thereby releasing or opening the first opening 11. In this situation, since the side cover 19 rotates in the sliding direction of the slidable supporting part 48, the operator can easily recognize the sliding direction of the slidable supporting part 48.

Next, a drawing step of drawing the slidable supporting part 48 which supports the roll body-holder 35 to the outside of the casing 30 via the first opening 11 which has been opened or released is performed. In the drawing step, as depicted in FIGS. 6 and 8, the operator firstly hooks his or her finger(s) to the handle 95 of the right holding plate 92E and draws the slidable supporting part 48 up to the drawn position located at the outside of the casing 30. In this situation, the front rail part 91A and the rear rail part 91B of the slide rail 91 moves in the left-right direction following, respectively, the front connecting part 92A and the rear connecting part 92B of the holding stand 92. As a result, the holding stand 92 protrudes rightward greatly than the slide rail 91. With this, the roll body 37 installed in the roll body-holder 35 is exposed from the sheet accommodating space 30C to the outside of the casing 30.

Next, an installing and detaching step of installing (attaching) and detaching the roll body 37 with respect to the roll body-holder 35 is performed. In the installing and detaching step, the operator firstly holds the left flange 35B and the right flange 35C and lifts the roll body 35 upward, thereby detaching the roll body-holder 35 from the slidable supporting part 48. Next, the operator releases the locking of the locking mechanism 96 to thereby detach the right flange 35C from the bar member 35A. Then, the operator detaches the roll body 37 (the core tube in a case that all of the sheet S has been drawn from the roll body 37) from the bar member 35A, and inserts the bar member 35A into the core tube of a new roll body 37. In this state, the operator inserts the bar member 35A into the through hole of the right flange 35C. In this situation, the operator causes the left flange 35B to make contact with the left end of the roll body 37 and causes the right flange 35C to make contact with the right end of the roll body 37, in accordance with the width of the roll body 37. In this state, the operator locks the locking mechanism 96 to thereby fix the position, of the right flange 35C, with respect to the bar member 35A.

Next, the operator installs the roll holder 35 in the slidable supporting part 48. Specifically, the operator places the left flange 35B and the right flange 35C in the placement part 92C, while the operator is inserting the protruding part of the left flange 35B into the left cutout part 93 of the left holding plate 92D from thereabove, and inserting the right end part of the bar member 35A into the right cutout part 94 of the right holding plate 92E from thereabove.

Next, the operator slides, via the first opening 11, the slidable supporting part 48 up to the accommodated position at which the slidable supporting part 48 is accommodated in the sheet accommodating space 30C of the casing 30. With this, the new roll body 37 installed in the roll body-holder 35 is accommodated in the sheet accommodating space 30C.

Lastly, a closing step of closing (covering) the first opening 11 is performed. In the closing step, the operator firstly rotates the side cover 19 from the open position to the close position to thereby close the first opening 11. Next, the operator rotates the first upper cover 31A from the open position to the close position.

### EFFECT OF EMBODIMENT

In the sheet conveying apparatus 10, since the operator is capable of sliding the slidable supporting part 48 up to the drawn position at which at least a part of the slidable supporting part 48 is positioned at the outside of the casing 30 with respect to the first opening 11, the operator is capable of detaching (taking out) the roll body 37 from the roll body-holder 35 at the drawn position of the slidable supporting part 48. Accordingly, the operation of supporting the roll body 37 is reduced or made easy in a case that the roll body 37 is being detached from the sheet accommodating space 30C of the casing 30. The operator is capable of sliding the slidable supporting part 48 up to the accommodated position at which the slidable supporting part 48 is accommodated in the sheet accommodating space 30C of the casing 30, in a state that the roll body-holder 35 holding the roll body 37 is supported by the slidable supporting part 48. Accordingly, the operation of supporting the roll body 37 is reduced or made easy in a case that the roll body 37 is being accommodated in the sheet accommodating space 30C of the casing 30. Thus, the operator is capable of replacing the roll body 37 smoothly.

In the sheet conveying apparatus 10, since the operator is capable of hooking his or her finger(s) to the handle 95 of the right holding plate 92E and sliding the slidable supporting part 48 up to the drawn position, the operator is capable of easily sliding the slidable supporting part 48 to the outside of the casing 30.

In the sheet conveying apparatus 10, the first opening 11 via which the sheet accommodating space 30C of the casing 30 is opened to the outside is formed at the lower part on the rear side in the right wall part 30R of the casing 30. Accordingly, since the sheet S can be drawn in the up direction and then can be conveyed in the front direction, the conveying route 43 of the sheet S can be made short. This is because, in a case that the first opening 11 via which the sheet accommodating space 30C of the casing 30 is opened to the outside is formed at a lower part on the front side in the right wall part 30R of the casing 30, there arises a necessity to once convey the sheet S in the rear direction, to move the sheet S upward, and then to convey the sheet S in the front direction.

In the sheet conveying apparatus 10, since the roll body-holder 35 supported by the slidable supporting part 48 holds the roll body 37 so that the axis line of the core tube of the roll body 37 is along the left-right direction, the conveying part is capable of easily conveying, in the front-rear direction, the sheet S drawn from the roll body 37.

In the sheet conveying apparatus 10, since the left end surface and the right end surface of the roll body 37 are covered, respectively, by the left flange 35B and the right flange 35C, such a situation is suppressed that the operator touches the roll body 37 in a case that the operator installs (attaches) and/or detaches the roll body-holder 35 with respect to the left holding plate 92D and the right holding plate 92E. Accordingly, the operator is less likely to dirty the roll body 37.

In the image recording apparatus 100, the operator is capable of replacing of the roll body 37 smoothly.

In the image recording apparatus 100, since the plurality of nozzles 38A of the recording part 38 discharge the ink toward the sheet S, it is possible to perform printing suitably on the sheet S.

In the method of replacing the roll body 37, since the operator draws the slidably supporting part 48, via the first opening 11 of the casing 30, to the outside of the casing 30 in the drawing step, the operator is capable of detaching the roll body-holder 35 from the slidable supporting part 48 at the outside of the casing 30 in the installing and detaching step. Accordingly, the operation of supporting the roll body 37 is reduced or made easy in a case that the roll body 37 is being detached from the sheet accommodating space 30C of the casing 30. Since the operator is capable of sliding the slidable supporting part 48 to the sheet accommodating space 30C of the casing 30, in a state that the roll body-holder 35 is installed in the slidable supporting part 48 in the accommodating step, the operation of supporting the roll body 37 is reduced or made easy in a case that the roll body 37 is being accommodated in the sheet accommodating space 30C of the casing 30. Thus, the operator is capable of replacing the roll body 37 smoothly.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### MODIFICATION

In the above-described sheet conveying apparatus 10, although the side cover 19 is rotated about the third rotation axis B extending in the front-rear direction to thereby open and close the first opening 11, it is allowable that the side cover 19 slidably moves in the front-rear direction to thereby open and close the first opening 11. Further, although the side cover 19 is rotatably attached to the right end part of the lower wall part 30D of the casing 30, it is allowable that the side cover 19 is detachable with respect to the casing 30. The third rotation axis B may be positioned at the upper end side of the side cover 19 so that the lower end side of the side cover 19 rotates about the third rotation axis B.

In the above-described sheet conveying apparatus 10, although the first opening 11 via which the sheet accommodating space 30C of the casing 30 is opened to the outside is formed in the right wall part 30R of the casing 30, it is allowable that the first opening 11 is formed in the left wall part 30L or the rear wall part 30B of the casing 30.

In the above-described sheet conveying apparatus 10, although the roll body-holder 35 is detachable from the slidably supporting part 48, it is allowable that the roll body-holder 35 is not detachable. In such a case, the roll body-holder 35 is configured to be capable of holding the roll body 37 in a state that the roll body-holder 35 is attached to the slidable supporting part 48. In this aspect, in a case that a member such as the bar member 35A is provided on the roll body-holder 35, the bar member 35A abuts against or makes contact with the roll body 37 when the roll body 37 is (being) installed in the roll body-holder 35, thereby making it impossible to install the roll body 37 in the roll body-holder 35. Accordingly, in this aspect, a shaft or a bearing is provided on the both sides of the roll body 37, and the bearing or the shaft is provided on the both sides (for example, the left flange 35B and the right flange 35C) of the roll body-holder 35. This aspect may be configured such that, in a case that the roll body 37 having the shaft or the bearing is installed in the roll body-holder 35 having the bearing or the shaft, the bearing receives the shaft and the shaft is connected to the driving source in the casing 30.

In the above-described sheet conveying apparatus 10, although the roll body 37 is accommodated in the sheet accommodating space 30C of the casing 30 such that the axis line of the core tube is along the left-right direction, it is allowable that the roll body 37 is accommodated in the sheet accommodating space 30C of the casing 30 such that the axis line of the core tube is along the front-rear direction or along the up-down direction.

In the above-described sheet conveying apparatus 10, although the water-based ink including the water, the pigment and the thermoplastic resin fine particles is made to be fixed to the sheet S by the heat of the fixing part 39, the ink is not particularly limited or restricted, provided that the ink is capable of forming an image on the sheet S. For example, it is allowable to use, as the ink, an ink which does not require any heating. In such a case, the fixing part 39 may be omitted.

Although the above-described sheet conveying apparatus 100 is the ink-jet printer provided with the recording part 38 which performs the recording in the ink-jet recording system, the image recording apparatus 100 is not limited to be the ink-jet printer, provided that the image recording apparatus 100 is capable of recording an image on a sheet. For example, the image recording apparatus 100 may be a thermal printer or a laser printer. In such a case, for example, the recording part 38 may be a thermal head or a photosensitive drum, etc.

In the above-described sheet conveying apparatus 10, although the tensioner 45 is rotatably supported by the side frames 20, 21 and is constructed of the roller to which the urging force in the rear direction is applied by the urging member such as a spring, etc., the tensioner 45 is not particularly limited, provided that the tensioner 45 is capable of guiding, along the conveying route 43, the sheet S drawn from the roll body 37 in the sheet accommodating space 30C while applying the tensile force to the drawn sheet S. For example, it is allowable that the tensioner 45 is constructed of a flap rotatably supported by the side frames 20, 21. The flap has a shape obtained by curving a flat plate extending in the up-down direction and the left-right direction so as to protrude in the rear direction. The flap is rotatable among a guiding position at which the flap guides the sheet S, a projecting position which is located on the rear side of the guiding position, and a retracted position which is located on the front side of the guiding position, with an upper end of the flap as the rotation axis.

What is claimed is:

1. A sheet conveying apparatus comprising:
a casing having an opening;
a cover configured to uncover and cover the opening;
a holder configured to hold a roll body, the roll body including a sheet being rolled;
a slidable support attached to the casing, the slidable support being configured to support the holder, the slidable support being configured to slide to an accommodated position at which the slidable support is accommodated within the casing and to a drawn position at which at least a part of the slidable support is positioned at outside of the casing with respect to the opening; and
a conveyer configured to convey the sheet of the roll body in a state that the slidable support is at the accommodated position.

2. The sheet conveying apparatus according to claim 1, wherein the slidable support has a handle.

3. The sheet conveying apparatus according to claim 1, wherein the cover is configured so that first one of an upper end side and a lower end side of the cover rotates, with second one of the upper end side and the lower end side of the cover as a rotation axis; and
the slidable support is configured to slide in a direction orthogonal to an axis line of the rotation axis.

4. The sheet conveying apparatus according to claim 3, wherein the cover is configured so that the upper end side of the cover rotates with the lower end side of the cover as the rotation axis.

5. The sheet conveying apparatus according to claim 1, wherein the conveyer is configured to convey the sheet along a front-rear direction of the casing; and
the opening is positioned at a lower rear part of one of side walls in a left-right direction of the casing, the left-right direction being orthogonal to the front-rear direction of the casing and orthogonal to an up-down direction of the casing.

6. The sheet conveying apparatus according to claim 5, wherein the holder supported by the slidable support is configured to hold the roll body so that an axis line of the roll body is along the left-right direction of the casing.

7. The sheet conveying apparatus according to claim 1, wherein the slidable support includes:
a slide rail; and
a holding stand supported by the slide rail, the holder being configured to be attached to and detached from the holding stand; and
the holder includes:
a bar configured to be inserted into a central hole of the roll body;
a first flange configured to be positioned at a first end of the bar so as to face a first end surface of the roll body; and
a second flange configured to be positioned at a second end of the bar so as to face a second end surface of the roll body.

8. An image recording apparatus comprising:
the sheet conveying apparatus as defined in claim 1; and
a recorder configured to record an image on the sheet conveyed by the conveyer.

9. The image recording apparatus according to claim 8, wherein the recorder is configured to discharge an ink toward the sheet.

10. A roll body replacing method for replacing a roll body accommodated in an inside of a casing in a state that the roll body is held by a holder, the roll body including a sheet being rolled, the roll body replacing method comprising:
uncovering an opening of the casing by moving a cover of the casing;
drawing a slidable support configured to support the holder to an outside of the casing via the opening;
detaching the holder from the slidable support drawn to the outside of the casing and installing the holder holding a new roll body to the slidable support;
sliding the slidable support, via the opening, to the inside of the casing; and
covering the opening of the casing by moving the cover of the casing.
